(19) United States
(12) Patent Application Publication
(10) Pub. No.: US 2009/0144104 A1
(43) Pub. Date: Jun. 4, 2009

(54) System and Method of Selectively Notifying Consumers of Product Recalls

(75) Inventor: Claire Marie Johnson, Clifton Park, NY (US)

Correspondence Address: DELAIN LAW OFFICE, PLLC, 107 NORTH COLLEGE ST., SCHENECTADY, NY, 12305, US

(73) Assignees: Scott Kevin Johnson, Clifton Park, NY (US); SMARTTOYCHOICE, LLC, Clifton Park, NY (US)

(21) Appl. No.: 11/948,943

(22) Filed: Nov. 30, 2007

(51) Int. Cl. G06F 17/30

(52) U.S. Cl. 705/7

(57) ABSTRACT

Described herein is a system and method of using the system for notifying consumers regarding product recall comprising: assignment of a unique user account to a newly registered consumer by an internet-based product recall notification system, the user account comprising a database wherein all products registered by that consumer are listed and a web interface whereon the products the consumer has listed as owned are listed with product recall alert-level status shown, and the unique user account requiring a logon verification method that is selected from the group consisting of username-and-password match, username match, and password match; the product recall notification system collecting consumer contact information; the product recall notification system collecting product information from the consumer about one or more products that the consumer has acquired; the product recall notification system sending regular periodic email to the registered consumers; the product recall notification system responding to email returned undeliverable; the product recall notification system receiving information about a product recall; the product recall notification system comparing the information received about the product recall to the consumer's data; the product recall notification system generating an email alert at a level determined by the match between the consumer's registered product and a recalled product to the consumer notifying the consumer about the recall of the registered product; and the product recall notification system generating a flashing screen alert at a level determined by the match between the consumer's registered product and a previously recalled product when the consumer enters information about a product that has previously been recalled.

### BACKGROUND OF THE INVENTION

1. Field of the Invention

This invention is in the field of product recall notification, specifically internet-based communication method regarding product recall notifications.

2. Description of Related Art

U.S. Pat. No. 7,044,380, issued May 16, 2006 to Knehr-McLaren, et al., teaches methods of communicating product status information that include maintaining a record of a product identification string associated with a product of a user, the product identification string being associated with a corresponding batch of the product. A batch status request is transmitted to a directory service maintaining batch status information at selected intervals and/or responsive to a user request and the requested batch status information for the product 106 is received. The batch status request need not include personal information of the user. Related directory services, systems and computer program products are also provided.

US Patent Application 20070069004 (Adler, Robert M., inventor) published Mar. 29, 2007, teaches a method of broadcasting product-recall advisory alerts via communications networks where a central notification computer is provided to broadcast advisory alerts to electronic device addresses stored in a subscriber database in a text, oral, pictorial, and computer retrievable format. The subscriber database contains subscriber data sets which each include the electronic device address, subscriber year of birth, and at least one geographic location associated with the electronic device address. When an advisory alert is initiated due to a product-recall, the affected subscribers are determined by geographic area, age, recreational activities, elderly parents, or other demographics is determined, and a geographic area defined by a perimeter is associated with the advisory alert. An algorithm retrieves addresses of the electronic devices associated with affected subscribers and the advisory alert 400 is transmitted to the electronic device addresses.

United States Patent Application 20070205258 (SELF, Matthew, et al., inventors), published Sep. 6, 2007, teaches systems and methods for product information coding and authentication for product tracking purposes are disclosed here. One embodiment includes generating a plurality of product codes, each product code being a unit level code that is unique for each item, maintaining product information associated with the plurality of product codes of a plurality of items, and providing at least part of the product information associated with a product code of an item in response to receiving a request to authenticate whether the product code is one of the generated product codes.

Canadian Patent Application 02473314 (Mansfield, Richard B., inventor), published Oct. 16, 2003 under International Publication Number WO 03/085578 A1, teaches a system for determining customer identifers (CIDs) associated with purchase of product items which are recalled that includes a computer database management system and network. Consumers associated with the determined CIDs are notified of the recall of the products.

European Patent Office Patent Application US2007239502 (Babu, Suresh R., inventor), published Oct. 11, 2007, teaches a computerized recall management tool permits an organization to recognize and proactively manage events that can indicate a need to initiate a product recall. Product performance data often is made available to an organization through very diverse communication channels, including from customers, distributors, suppliers, governmental or industry agencies in addition to its internal manufacturing and testing sources. The recall management tool may include modules to recognize patterns of product defects from product performance data, to model an extent to which a product defect may proliferate throughout its distributed products, to alert operators when such patterns are detected, to manage regulatory reporting events and other notification milestones and to manage a recall itself.

The US Government provides several websites (through the USDA, the Department of Commerce, and other agencies) that list products that have been recalled, but the Government provides email alerts based upon categories of products to consumers regarding the recalls.

Another website, located at http://www.safetyalerts.com, provides searchable and browsable listings of recalled products by category and date. This site also provides email notifications to its subscribers based on types of products for which the subscriber requests notification of recalls. The emails from this site can be configured by the subscriber to arrive daily, weekly, monthly, or never. However, these emails are for the types of products being recalled, not for specific SKUs; nor are these emails coded by importance based on subscriber input.

Another website, located at http://www.recall-warnings.com, provides searchable and browsable listings of recalled products by category and date. This site appears to be a vertical portal linked listing of recalled products.

Another website, located at http://www.kidsindanger.org, provides information and advocacy regarding the safety of children's products. There is a notification system associated with this site. It is not a customizable system.

On information and belief, another website, located at http://www.kidsrus.com, may be planning to provide or may currently provide notification to consumers who purchase products at the website 110 and/or at a physical store that is franchised or otherwise associated with the KIDS R US® retailer brand. KIDS R US is a trademark or registered trademark of Geoffrey, Inc., a Delaware corporation.

On information and belief, another website, located at http://www.amazon.com, may currently be planning to provide or may currently provide product recall notification to consumers who purchased products at the website.

There is an unmet need in the art for a method to notify consumers of product recalls, based on the products that a consumer owns and not based in any way on the retailer from which the consumer purchases the product, in a way that is tailored to each individual consumer and in a way that each individual consumer will receive actual, as opposed to constructive, notice of the recall, in a way that differentiates between various likelihoods that the particular product being recalled is the product owned by the consumer, and have the opportunity to react to the product recall in a timely manner.

### BRIEF DESCRIPTION OF THE INVENTION

The present invention teaches a system and method for selectively providing consumers with actual notice about product recalls of products that the consumer owns such that the consumer can react to the recall in a timely manner. The invention uses various levels of internet-based (email and web-based) alerts to reflect the various likelihoods that the particular product being recalled is the product owned by the consumer. The product can be new or used, and the point of sale is immaterial to the notice.

### BRIEF DESCRIPTION OF THE DRAWINGS

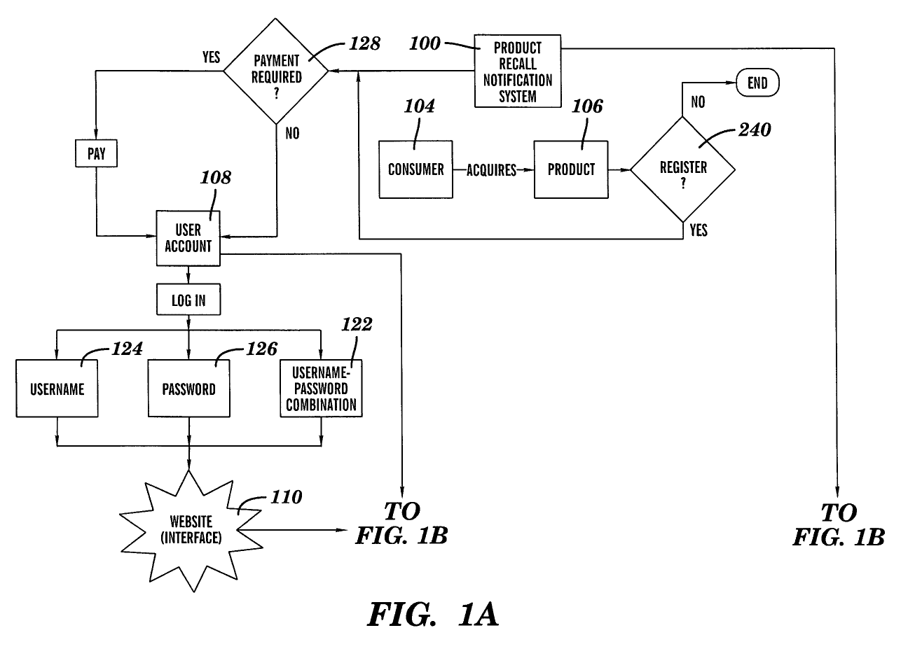

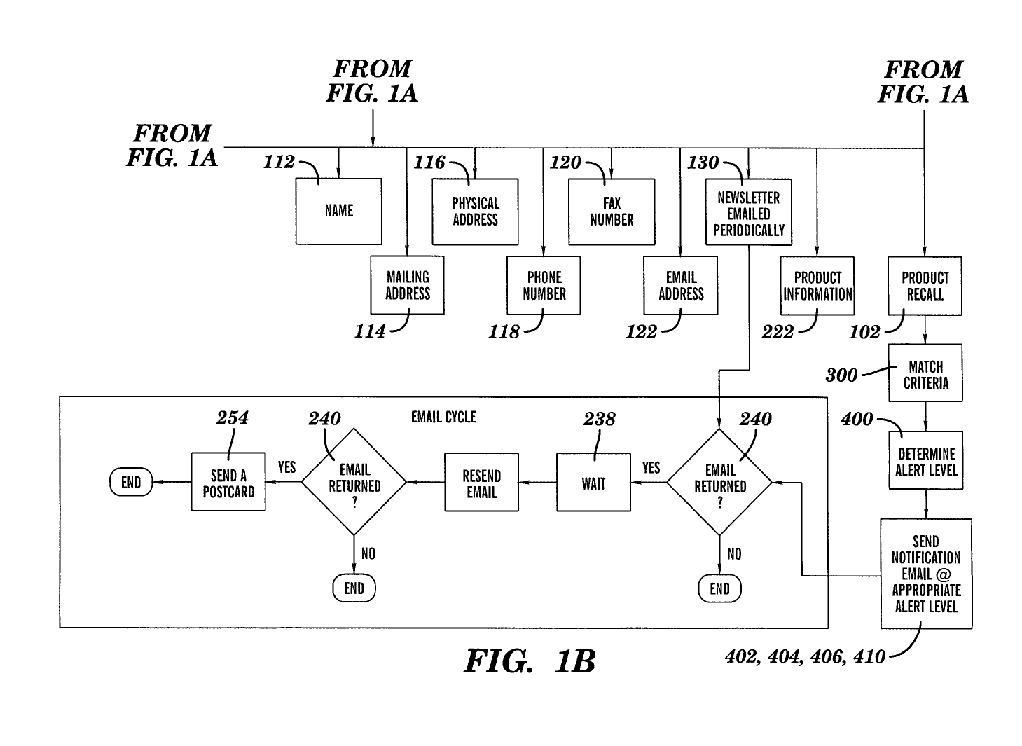

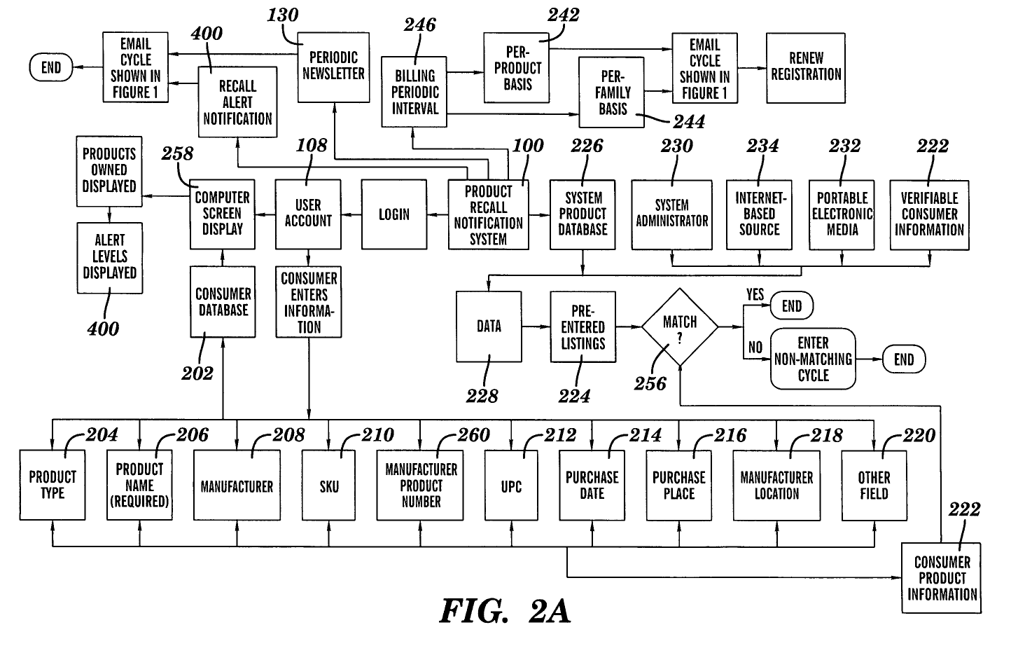

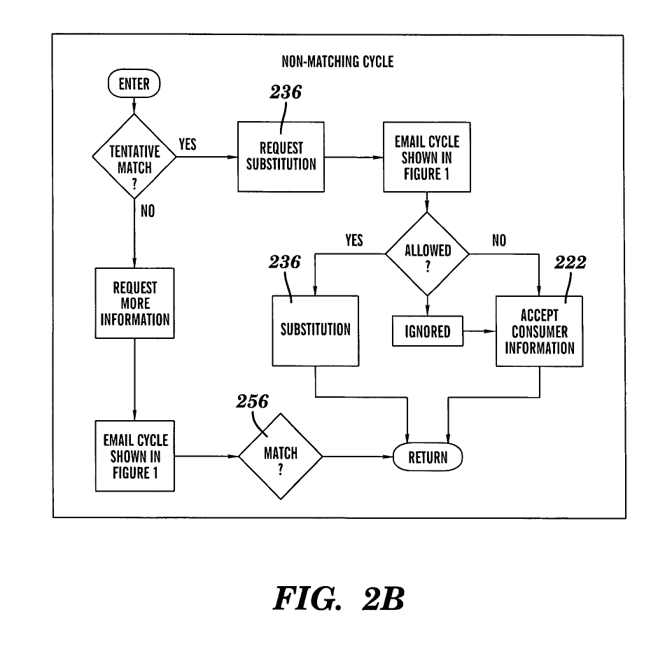

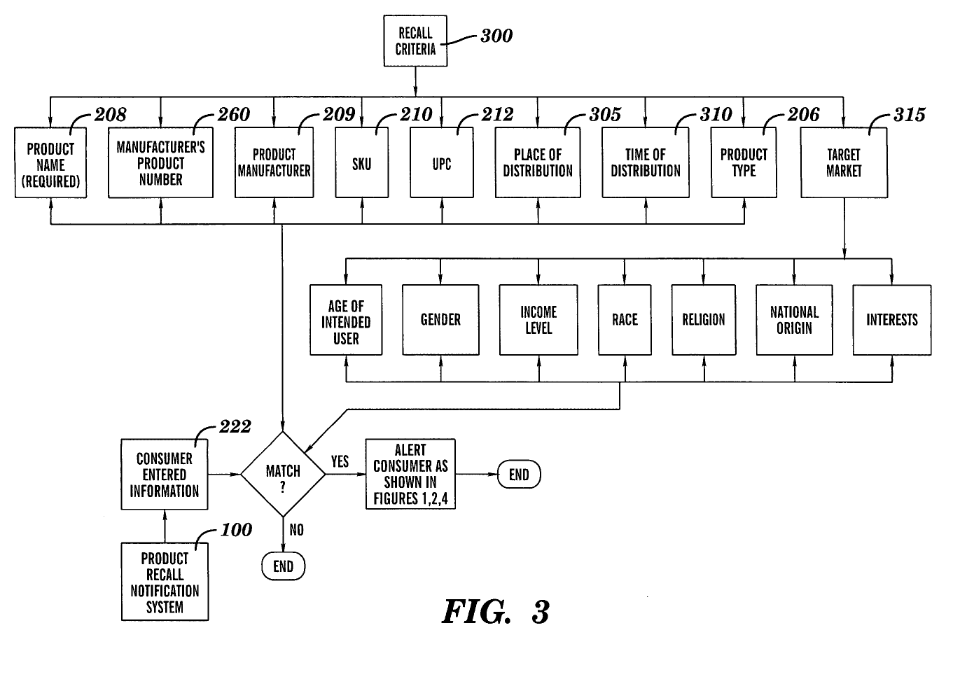

Referring now to FIG. 1, an internet-based product recall notification system 100 is shown.

Referring now to FIG. 2, a process 200 for communication with the consumer 104 is shown.

Referring now to FIG. 3, criteria 300 against which a recalled product 106 is matched are shown.

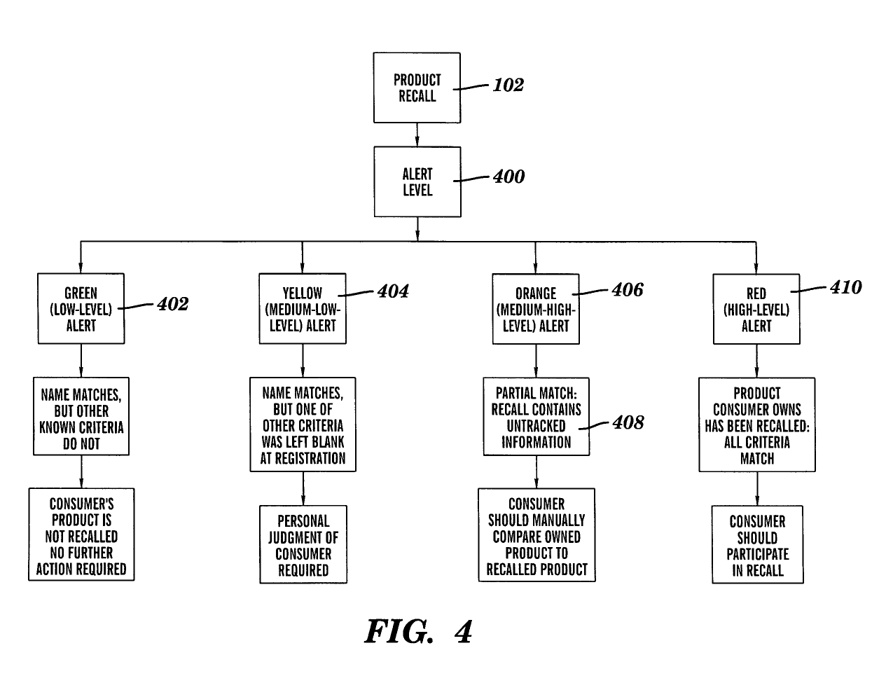

Referring now to FIG. 4, alert levels 400 that show the importance of the recall to the consumer are shown.

### DETAILED DESCRIPTION OF THE INVENTION

Referring now to FIG. 1, an internet-based product recall notification system 100 is shown.

A consumer 104 acquires a product 106. The product 106 may be new or used, and may be received as a gift or purchased from any source, the most likely sources being retail stores or outlets, which may include stores, roadside stands, mall kiosks, at-home product parties, or other physical retail location, and used-merchandise sales such as garage sales, For Sale classified advertisements, and online auctions. However, these sources are listed merely as examples; the listing is not intended to exclude other possible sources of products 106. After acquisition of either a new or used product 106, the consumer 104 decides whether to register the product 106 with the product recall notification system 100. If the consumer 104 decides not to register the product 106, the product recall notification system 100 ends and no further work is done.

If the consumer 104 decides to register, the consumer 104 must first set up a unique user account 108 in the product recall notification system 100 at a website 110 online. Certain information, such as name 112, mailing address 114, physical address 116, telephone number 118, fax number 120, and email address 122, is collected at registration 240, and the product recall notification system 100 assigns a unique user account 108 to the consumer 104. The consumer 104 then logs onto the website 110 using a security level that may be a username-and-password 126 combination 122, just a username 124, or just a password 126, and enters information 222 about the acquired product 106 and about the consumer 104. The product recall notification system 100 may or may not require payment 128 by the consumer 104; if the product recall notification system 100 requires payment 128, the consumer 104 enters payment 128 information in a form that is accepted by the product recall notification system 100, such as electronic funds transfer information, credit card information, ACH information, or other method of transferring funds from the consumer 104 to the product recall notification system 100. After registration 240, the product recall notification system 100 sends the consumer 104 a newsletter 130 at predetermined intervals using email 134; in the current embodiment, the newsletter 130 is sent quarterly, but it may be sent at other intervals within the scope of the invention. The consumer 104 may opt out of receiving the newsletter 130. In another embodiment, the consumer 104 may opt back in to receive the newsletter 130. When a product 106 that the consumer 104 has registered is recalled, the product recall notification system 100 matches the recalled product 106 to criteria 300 about the product 106 and the consumer 104 that the consumer 104 input when registering the product 106 and generates a recall notification 136 email 134 at the appropriate level of alert 400, as discussed infra.

Referring now to FIG. 2, a process 200 for communication with the consumer 104 is shown.

Each consumer 104 who registers with the product recall notification system 100 is assigned a unique user account 108 which contains a database 202 of the consumer's 104 reported products 106. The consumer 104 is required by the product recall notification system 100 to log into the user account 108 using a username-and-password combination 122. In another embodiment, a username 124 only may be required. In another embodiment, a password 126 only may be required. A listing of the consumer's 104 reported products 106 appears on the computer screen 258 when the consumer 106 logs into the product recall notification system 100, along with any recall notification 136 associated with that product 106.

The product recall notification system 100 interacts with the consumer 104 four times in the current embodiment; more or fewer interactions also fall within the scope of the invention.

The first interaction occurs when the consumer 104 purchases a product 106 and decides to register that product 106. At this point, the consumer 104 creates a user account 108 or logs into an existing user account 108 on the product recall notification system 100 and enters information 222 into the product recall notification system 100 regarding the product 106. The more information that is available to the product recall notification system 100, the better the matching of criteria 300 will be in the event of a product recall 102 of that product 106. Data such as the consumer's name 112, physical address 116, mailing address 114, telephone number 118, fax number 120, and email address 122 may be required in any combination so the product recall notification system 100 can contact the consumer 104 to send a regular email 134 or in the event of a product recall 102. Data regarding the product 106 is also requested: the product type 206, the product name 208, the manufacturer 210, the Stock Keeping Unit (hereinafter “SKU”) code 210, the manufacturer's code 260 the Universal Product Code (hereinafter “UPC”) 212, the purchase date 214, and the place of purchase 216 comprise the current embodiment; other fields 220 may be included (such as location of manufacturer 218, for example) within the scope of the present invention. The product recall notification system 100 requires only the product name 206 to be filled in, but the accuracy of the recall notification 136 product recall notification system 100 is directly related to the number of database fields 220 that the consumer 104 fills in and the accuracy of the consumer's product information 222 provided in the consumer database 204.

The product recall notification system 100 checks the consumer's product information 222 against a pre-entered listing 224 of known products 106. The pre-entered listing 224 comprises a product database 226 within the product recall notification system 100, and the product data 228 therein may be manually entered by a system administrator 230, or it may be entered by a consumer 104 and manually verified by a system administrator 230 or automatically verified by the product recall notification system 100 itself, or it may be transferred from portable electronic media 232 such as CD-ROM, DVD-ROM, tape, diskette, portable hard drive, or other portable electronic media 232, or it may be automatically entered or downloaded from one or more internet-based sources 234 such as manufacturers' websites, retail store websites, or government websites.

If the consumer product information 222 entered matches a pre-entered listing 224 for that product 106, the product recall notification system 100 accepts the information 222 without contacting the consumer 104.

If the consumer product information 222 entered does not match the pre-entered listing 224 for that product 106, but can be matched tentatively to a pre-entered listing 224 for that product 106, the product recall notification system 100 generates an email 134 to the consumer 104 that indicates what the pre-entered listing 224 is and asks the consumer 104 to accept or reject the substitution 236 of the pre-entered listing 224 for the consumer product information 222. If the consumer 104 accepts the substitution 236, the substitution 236 is made to match the consumer's 104 product 106 with the pre-entered listing 224. If the consumer 104 rejects the substitution 236, then the consumer product information 222 becomes part of the consumer database 202, and any inaccuracies in the information 222 decrease the accuracy of the product recall notification system 100. If the consumer 104 ignores the email 134, the product recall notification system 100 attempts to send another email 134 the consumer 104 at least one more time after a pre-determined time 238 that may range from one second to one year, has elapsed. In the present embodiment, this pre-determined time 238 is three days. If the consumer 104 continues to ignore the email 134 for a second pre-determined time 238, which may range from one second to one year, the product recall notification system 100 accepts the consumer's 104 input as part of the consumer database 202. In the present embodiment, the second pre-determined time 238 is one week. Any inaccuracies in the consumer product information 222 decrease the accuracy of the product recall notification system 100.

If the product recall notification system 100 cannot match the consumer's 104 data to any product 106 in the pre-entered listing 224, the product recall notification system 100 generates an email 134 to the consumer 104 requesting more information. If the consumer 104 responds to the email 134 with more information about the product 106, the product recall notification system 100 again attempts to match the product 106 against the pre-entered listing 224. If that match is successful, there is no further action at this time. If that match is unsuccessful, the product recall notification system 100 generates another email 134 requesting more information; if the consumer 104 responds, another match attempt is made. This continues until either the consumer 104 fails to respond to an email 134 or a match is successfully made. The product recall notification system 100, in another embodiment, may limit the number of times a request for more information is made.

If the consumer 104 is the first to enter information about a product 106, and if that information is verified either manually by a system administrator 230 or through any one of several automatic verification methods which are not part of this invention, then the consumer product information 222 is entered into the pre-entered listings 224 and into the consumer database 202.

If the consumer 104 fails to respond to an email 134 requesting more information about the product 106 entered, the product recall notification system 100 accepts the consumer's 104 input into the consumer database 202. However, since no match is possible, no recall notifications 136 can be sent to the consumer 104.

The second contact is billing for registration 240. Registration 240 may be billed on a per-product basis 242 or on a per-family basis 244; the per-family basis 244 covers all products 106 owned by the family and is the preferred embodiment of the invention. Registration 240 may be required to be renewed at periodic intervals 246, such as weekly, semimonthly, monthly, bimonthly, quarterly, semiannually, annually or another interval, or the product recall notification system 100 may accept a one-time registration 240. The current embodiment provides a set fee billed annually covering all products 106 registered. Registration 240 may but need not require that the consumer 104 pay a registration fee 248 to register a product 106 or a family's products 106. The registration fee 248 may or may not vary depending on the type of registration 240 (per-family 244 or per-product 242), the class 250 of products 106 registered (toys and cars are two of many examples of classes 250 of products 106), the number of classes 250 of products 106 registered, the country in which the consumer 104 resides, the tax structure of the state or country in which the consumer 104 resides.

The third contact is the newsletter 130. This is provided as a service to consumers 104 in the product recall notification system 100 and is sent on a regular periodic basis 252 using email 134 to those consumers 104 who receive the newsletter 130. Consumers 104 may opt out of receiving the newsletter 130; in another embodiment, the consumer 104 may opt back in and receive the newsletter 130 again after opting out. The regular periodic basis 252 may be daily, semiweekly, weekly, biweekly, semimonthly, monthly, quarterly, semiannually, or annually. It is possible to opt out of receiving the newsletter 130 at any time by clicking on a link provided in the newsletter 130 or by visiting a website 110 and selecting an opt-out option. The newsletter 130 provides general information about recalls that have occurred since the last newsletter 130 was issued. Another purpose of the newsletter 130 is maintenance of the database of consumer 104 contact information 112, 114, 116, 118, 120, 122. If a newsletter 130 is returned as undeliverable email 134, the product recall notification system 100 waits for a predetermined time 238, currently twenty-four hours but other timeframes are also within the scope of the invention, then sends the newsletter 130 again. If the newsletter 130 is returned undeliverable a second time, the product recall notification system 100 prints out a postcard 254 addressed to the consumer 104 at the last known mailing address 114 of the consumer 104 and requests that the consumer 104 update the email address 122.

The fourth contact is the notification of product recall 102. The notification method is a multi-tiered product recall notification system 100, the alert levels 400 being determined by a database match 256 between the product recall 102 and the consumer product information 222. In the present embodiment, the product recall notification system 100 contains four alert levels 400. When a product 106 is recalled, the product recall notification system 100 matches the product 106 being recalled to the consumer product information 222 and sends an email 134 at the appropriate alert level 400. If this email 134 is returned undeliverable, the product recall notification system 100 waits for a predetermined time 238, currently twenty-four hours but other timeframes are also within the scope of the invention, then sends the notification email 134 again. If the notification email 134 is returned undeliverable a second time, the product recall notification system 100 prints out a postcard 254 addressed to the consumer 104 at the last known address of the consumer 104 and requests that the consumer 104 update the email address 122. This postcard 254 may also contain an appropriate alert level 400 notice of the product recall 102.

If the consumer 104 enters information 222 about an already-recalled product 106 into the consumer database 202, the product recall notification system 100 flashes a recall notice at the appropriate alert level 400 on the consumer's 104 computer screen 258.

Referring now to FIG. 3, the criteria 300 against which a recalled product 106 is matched are shown.

Recall criteria 300 may include product name 208, manufacturer's product number 260, SKU 210, UPC 212, manufacturer 210, places of distribution 305, times of distribution 310, product type 206, target market 315, where target market 315 may include such factors as intended age of the user, gender, income level, race, religion, national origin, and interests. These criteria 300 are matched by the product recall notification system 100 against information input by the consumer 104 at the time of registration 240, which includes contact information as described in FIG. 2, and product 106 information about the particular product 106 purchased by that consumer 104.

Referring now to FIG. 4, the email 134 alert levels 400 that show the importance of the recall 102 to the consumer 104 are shown.

A Green, or low-level, alert 402 is issued when the product name 208 of the recalled product 106 matches the product name 208 in the consumer product information 222, but one of the other variables does not match, so the consumer's 104 product 106 is NOT recalled. This gives the consumer 104 the reassurance that their particular product 106 is not part of a recall 102; there is no further action required.

A Yellow, or medium-low level, alert 404 is issued when the product name 208 of the recalled product 106 matches the product name 208 input by the consumer 104, but one of the other four criteria 300 was left blank by the consumer 104, so the consumer 104 may not be able to manually compare their product 106 to the recalled product 106. It is possible that their product 106 was recalled; the consumer 104 can use personal judgment as to whether to continue to use the product 106.

An Orange, or medium-high level, alert 406 is issued when the product name 208, manufacturer's product number 260, SKU 210, and/or UPC 212, and purchase date 214 of the consumer's product 106 match the recall 102, but the recall 102 contains untracked information 408. It is likely the consumer's product 106 is recalled but the consumer 104 must manually compare their product 106 to the recall 102.

If the recall 102 matches all criteria 300 input by the consumer 104 at registration 240, the product recall notification system 100 sends a red, or high-level, alert 410 to the consumer 104 at the consumer's 104 registered email address 122. This indicates that the product 106 the consumer 104 owns is the product 106 being recalled and includes the hazard and remedy details of the recall 102.

If the product 106 was subject to recall 102 prior to the consumer's 104 entering information 222, a notice flashes on the consumer's 104 computer screen 258 when the consumer 104 enters the information into the consumer database 202, at the appropriate recall level of alert 402, 404, 406, 410.

The differing levels of alerts 400 are customized by the consumer product information 222 at the time a product 106 is registered. The consumer 104 can input all information 222 that may be available with a new product 106; if the consumer 104 does this, the resulting emails 134 are tailored specifically to that consumer's 104 owned products 106. However, it is not always possible to input all information available about a newly acquired product 106. If a used product 106 is purchased, for example, the information that is originally available with the product 106 is less likely to still be available. The consumer 104, in this case, inputs all the information 222 available at the time the product 106 is registered. This situation leads to more orange 404 and yellow 406 alerts. When a product 106 is closely matched by having most or all of the available information 222, the product recall notification system 100 generates more closely matched emails 134, designated by green 402 and red 410 alerts.

In an alternate embodiment, the manufacturer 210 may subscribe to the notification product recall notification system 100 described herein a line of its merchandise, and provide email address 122 contact information for each consumer 104 of all products 106 within that line for notification of any future product recall 102. The manufacturer 210 or retailer would be required to collect (a) the consumer's email address 122; and (b) the consumer's 104 permission to add the email address 122 to the email addresses 122 to be registered. The manufacturer 210 could then submit a bulk registration 240 to the product recall notification system 100 at any interval. The bulk registration 240 may or may not be discounted in price to register in the product recall notification system 100. Should the consumer 104 deny permission to the manufacturer 210 to register his or her email address 122, the manufacturer 210 would delete that email address 122 from the list of email addresses 122 to be registered, or would not add the email address 122 to the list of email addresses 122 to be registered. The manufacturer 210 may or may not mark up the price of such registered product lines 106 to the retail cost of the product 106. This registration 240 would be provided by the manufacturer 210 as a service for its customers 106. The remainder of the described invention performs in a manner identical to that described herein.

In another alternate embodiment, the product recall notification system's 100 pre-entered listings 224 may be configured to interact with a merchant's 412 database 414, particularly the database 414 of an online merchant 412. The consumer 104 would purchase a product 106 online and follow a link to automatically load the data from that online merchant's 412 database 414 into a new or existing user account 108 in the product recall notification system 100.

The embodiments provided here are examples only and are not intended to be a complete listing of possible embodiments, nor should they be construed as an exclusive listing of embodiments. Variations in the described invention and its uses are possible within the scope of this disclosure without departing from the subject matter coming within the scope of claims to be examined, and a reasonable equivalency thereof, which I regard as my invention.

I claim:

1. A method of notifying consumers regarding retail product recall comprising:
assignment of a unique user account to a newly registered consumer by an internet-based product recall notification system, the user account comprising a database wherein all products registered by that consumer are listed and a web interface whereon the products the consumer has listed as owned are listed with product recall alert-level status shown, and the unique user account requiring a logon verification method that is selected from the group consisting of username-and-password match, username match, and password match;
the product recall notification system collecting consumer contact information;
the product recall notification system collecting product information from the consumer about one or more products that the consumer has acquired;
the product recall notification system sending regular periodic email to the registered consumers;
the product recall notification system responding to email returned undeliverable;
the product recall notification system receiving information about a product recall;
the product recall notification system comparing the information received about the product recall to the consumer's data;
the product recall notification system generating an email alert at a level determined by the match between the consumer's registered product and a recalled product to the consumer notifying the consumer about the recall of the registered product; and
the product recall notification system generating a flashing screen alert at a level determined by the match between the consumer's registered product and a previously recalled product when the consumer enters information about a product that has previously been recalled.

2. The method of claim further comprising the consumer information collected from the consumer comprises name, mailing address, physical address, telephone number, fax number, and email address.

3. The method of claim further comprising the product information collected from the consumer comprises any combination of product type, product name, manufacturer, manufacturer's product number, SKU, UPC, purchase date, place of purchase, and location of manufacturer.

4. The method of claim further comprising the regular periodic email is a newsletter that is sent on a period selected from the group consisting of daily, semiweekly, weekly, biweekly, semimonthly, monthly, quarterly, semiannually, and annually.

5. The method of claim further comprising the product recall notification system responds to email returned undeliverable by re-sending the email after a predetermined period of time has elapsed.

6. The method of claim further comprising the predetermined period of time being twenty-four hours.

7. The method of claim further comprising the product recall notification system responding to a resent email being returned undeliverable by printing a postcard labeled with the consumer's last known mailing address requesting that the email address be updated.

8. The method of claim further comprising the product recall notification system receiving information about a product recall from a source selected from the group consisting of manually entered, downloaded from the internet, and transferred from electronic media such as CD-ROM, DVD-ROM, tape, and diskette.

9. The method of claim further comprising the alert email level comprising one of a green alert, a yellow alert, an orange alert, and a red alert.

10. The method of claim further comprising the green alert being issued when the product name of the recalled product matches the product name input by the consumer, but one of the other variables does not match, so that product is NOT recalled.

11. The method of claim further comprising the orange alert being issued when the product name, manufacturer's product number, SKU and/or UPC, and the purchase date of the consumer's product match the recall, but the recall contains information not tracked by the product recall notification system, the orange alert containing the hazard and remedy details of the recall.

12. The method of claim further comprising a yellow alert being issued when the product name of the recalled product matches the product name input by the consumer, but one of the other four criteria was left blank by the consumer, the yellow alert containing the hazard and remedy details of the recall.

13. The method of claim further comprising a red alert being issued when the product the consumer owns matches all the criteria of the product being recalled, the red alert containing the hazard and remedy details of the recall.

14. A product recall notification system comprising:
a consumer login mechanism where by a user account is entered through a method selected from the group consisting of username-and-password matching, username matching, and password matching;
a consumer-entered database containing registration of the acquisition of a new or used product in the an internet-based product recall notification system and information about that product;
a listing of all products that consumer has registered on the main screen shown after the consumer logs into the product recall notification system;
a collection of consumer contact information;
a regular periodic email sent to the registered consumers;
a response to email returned undeliverable;
a collection of information about consumer products, the information comprising the product name, the manufacturer of the product, the manufacturer's product number, the SKU, the UPC, the product type, the place of sale of the product, and the time of sale of the product;
a collection of information about a product recall;
a comparison of the information received about the product recall to the consumer's data;
a flashing-screen alert, at a level determined by the match between the collection of consumer-entered data and the recalled product, on the consumer's computer screen to notify the consumer about a previous recall of a newly registered product; and
an email alert, at a level determined by the match between the collection of consumer-entered data and the recalled product, sent to the consumer to notify the consumer about the recall of the registered product.

15. The system of claim further comprising the collection of consumer contact information comprising name, physical address, mailing address, telephone number, fax number and email address.

16. The system of claim further comprising the collection of consumer—entered product data comprising any combination of product type, product name, manufacturer, manufacturer's product number, SKU, UPC, purchase date, place of purchase, and location of manufacturer.

17. The system of claim further comprising the regular periodic email sent to the registered consumers being a newsletter that is sent on a period selected from the group consisting of daily, semiweekly, weekly, biweekly, semimonthly, monthly, quarterly, semiannually, and annually.

18. The system of claim further comprising the returned email response comprising re-sending the email after a predetermined period of time has elapsed.

19. The system of claim further comprising the predetermined period of time being twenty-four hours.

20. The system of claim further comprising the product recall notification system responding to a resent email being returned undeliverable by printing a postcard labeled with the consumer's last known mailing address requesting that the email address be updated.

21. The system of claim further comprising the alert email level comprising one of a green alert in which an alert is issued when the product name of the recalled product matches the product name input by the consumer, but one of the other variables does not match, so that product is NOT recalled; an orange alert in which the product name, manufacturer's product number, SKU and/or UPC, and the purchase date of the consumer's product match the recall, but the recall contains information not tracked by the product recall notification system, the orange alert containing the hazard and remedy details of the recall.; a yellow alert in which the product name of the recalled product matches the product name input by the consumer, but one of the other four criteria was left blank by the consumer, the yellow alert containing the hazard and remedy details of the recall.; and a red alert in which the product the consumer owns matches all the criteria of the product being recalled, the red alert containing the hazard and remedy details of the recall.

22. A method of notifying consumers regarding retail product recall comprising:
assignment of a unique user account to a newly registered consumer by an internet-based product recall notification system, the user account comprising a database wherein all products registered by that consumer are listed and a web interface whereon the products the consumer has listed as owned are listed with product recall alert-level status shown, and the unique user account requiring a logon verification method that is selected from the group consisting of username-and-password match, username match, and password match;
the product recall notification system collecting consumer contact information comprising name, mailing address, physical address, telephone number, fax number, and email address;
the product recall notification system collecting product information from the consumer about one or more products that the consumer has acquired comprising any combination of product type, product name, manufacturer, manufacturer's product number, SKU, UPC, purchase date, place of purchase, and location of manufacturer;
the product recall notification system sending regular periodic email to the registered consumers, the regular periodic email being a newsletter that is sent on a period selected from the group consisting of daily, semiweekly, weekly, biweekly, semimonthly, monthly, quarterly, semiannually, and annually;
the product recall notification system responding to email returned undeliverable by re-sending the email after a predetermined period of time has elapsed, the predetermined period of time being twenty-four hours, and if the resent email is returned undeliverable printing a postcard labeled with the consumer's last known mailing address requesting that the email address be updated;
the product recall notification system receiving information about a product recall from a source selected from the group consisting of manually entered, downloaded from the internet, and transferred from electronic media such as CD-ROM, DVD-ROM, tape, and diskette;
the product recall notification system comparing the information received about the product recall to the consumer's data;
the product recall notification system generating an email alert at a level determined by the match between to the consumer notifying the consumer about the recall of the registered product, the alert email level comprising one of a green, or low-level, alert in which an alert is issued when the product name of the recalled product matches the product name input by the consumer, but one of the other variables does not match, so that product is not recalled; an orange, or medium-low-level alert in which the product name, manufacturer's product number, SKU and/or UPC, and the purchase date of the consumer's product match the recall, but the recall contains information not tracked by the product recall notification system, the orange alert containing the hazard and remedy details of the recall; a yellow, or medium-high-level alert in which the product name of the recalled product matches the product name input by the consumer, but one of the other four criteria was left blank by the consumer, the yellow alert containing the hazard and remedy details of the recall; and a red, or high-level, alert in which the product the consumer owns matches all the criteria of the product being recalled, the red alert containing the hazard and remedy details of the recall; and
the product recall notification system generating a flashing screen alert on the consumer's computer screen at a level determined by the match between the consumer's registered product and a previously recalled product when the consumer enters information about a product that has previously been recalled.
